(19) United States
(12) Patent Application Publication
(10) Pub. No.: US 2009/0322061 A1
(43) Pub. Date: Dec. 31, 2009

(54) DECORATIVE TOWING HITCH SECURITY COVER

(76) Inventor: Eric Rodriguez, West Covina, CA (US)

Correspondence Address: SHELDON MAK ROSE & ANDERSON PC, 100 Corson Street, Third Floor, PASADENA, CA, 91103-3842, US

(21) Appl. No.: 12/163,832

(22) Filed: Jun. 27, 2008

(51) Int. Cl. B60D 1/60

(52) U.S. Cl. 280/507

(57) ABSTRACT

A towing hitch cover device comprising a housing connectable to a towing hitch assembly and a detachable decorative portion connected to the housing.

### BACKGROUND

This disclosure relates to covers for towing hitches. More particularly, to a decorative towing hitch cover with a detachable decorative portion that provides security, protection and lubrication.

There are many decorative and practical security devices for towing hitches available on the market. The two main types of towing hitch covers currently available are friction type covers and insert type covers. Friction type towing hitch covers come in a variety of styles and colors. Disadvantageously, friction type towing hitch covers require a tight fit to maintain their position while the vehicle travels. Because towing hitch assemblies require lubrication to function properly, the friction type covers will either remove the lubrication when placed on the towing hitch or require the user of the friction cover to remove the lubrication prior to placing the cover on the towing hitch. In the first instance, the lubricants will remain inside the hitch cover and will limit the storage of the cover to places that the user will not object to having the lubricants potentially staining the area. Additionally, the lubricants left inside the friction cover will become contaminated with dust, dirt and other particles that can act as an abrasive during the application and removal of the cover and ruin the chrome exterior covering of some towing hitches. Further, the friction type covers offer no way to secure the cover from theft.

Insert type towing hitch covers provide a way for the user to protect towbars. Towbars are the framework attached to the back of the tow vehicle, and a mount or tongue is the section that comprises the towing coupling that fits inside a towbar. These types of covers require the user to remove and store the mount or tongue prior to placing the cover insert into the towbar. This also leads to storage problems and does not provide any mechanism for protecting the lubricated surfaces of the hitch itself. Insert type covers do provide features to allow the user to lock the cover in place to prevent theft. However, with either cover currently available, the user is left with a mess.

Finally, both types of covers require that a user purchase an entire new cover if the user would prefer a different decoration or look to be associated with the user's vehicle. For example, if a user would like to demonstrate holiday cheer with a towing hitch cover, they would have to purchase an entirely different set of covers for each occasion.

Therefore, there is a need for a decorative towing hitch cover with a detachable decorative portion that provides security, protection and lubrication that does not suffer from these disadvantages.

### SUMMARY OF THE INVENTION

The invention meets this need by providing a towing hitch cover device comprising a housing that is connectable to a hitch assembly and a detachable decorative portion connected to the housing. The towing hitch cover device of claim 1, wherein the housing further comprises a) a proximal end portion, b) a mid-portion connected to the proximal end portion, c) a distal end portion connected to the mid-portion, d) an upper portion connected to the mid-portion, e) a first side portion connected to the mid-portion, f) a second side portion connected to the mid-portion, and g) a lower portion connected to the mid-portion, wherein the lower portion comprises an aperture, positioned at the proximal end portion, adapted to fit over the hitch assembly.

Optionally, the device can comprise a channel adapted to cover the hitch assembly and one or more apertures, extending through the housing and the channel, or extending through the mid-portion of the housing, that are adapted to allow passage of a lock mechanism.

In a preferred embodiment, the detachable decorative portion further comprises a decoration selected from the group consisting of a figure, a fantasy figure, a lighted decorative pattern, seasonal and holiday lighted decorations, human female figurine, human male figurine, an animal figurine, motorized vehicles, watercraft vehicles, occupational models, religious figurines, sport logos, sports figures, photographs and religious symbols. The detachable decorative portion can be connected to the upper portion of the housing, the first side portion of the housing, the second side portion of the housing, the upper portion of the housing and the first side portion of the housing, the upper portion of the housing and the second side portion, or the first side portion of the housing and the second side portion of the housing. Additionally, the detachable decorative portion comprises a means for attaching the detachable decorative portion to the housing.

In another embodiment, the housing further comprises an electrical connection located at the distal portion of the housing to provide power to the detachable decorative portion.

In yet another embodiment, the housing further comprises a zerc fitting for lubricating the hitch assembly, located on the upper portion at the proximal end portion of the housing.

### BRIEF DESCRIPTION OF THE DRAWINGS

These and other features, aspects and advantages of the present invention will become better understood with regard to the following description, appended claims, and accompanying figures where:

FIG. 1 is a diagram of a perspective view of a decorative towing hitch cover with a detachable decorative portion according to one embodiment of the invention;

FIG. 2 is a perspective view of the detachable decorative portion of the device illustrated in FIG. 1;

FIG. 3 is an end view of the detachable decorative portion of the device illustrated in FIG. 2;

FIG. 4 is a front view of the housing of the device illustrated in FIG. 1;

FIG. 5 is a side view of the housing of the device illustrated in FIG. 1;

FIG. 6 is a diagram of a locking mechanism useful with the device illustrated in FIG. 1 according to one embodiment of the invention;

FIG. 7 is a perspective view of a diagram of a decorative towing hitch cover with a detachable decorative portion according to another embodiment of the invention.

### DETAILED DESCRIPTION

The embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure where the element first appears. The following description is provided to enable any person skilled in the art to make and use the invention and sets forth the best modes contemplated by the inventor, but does not limit the variations available. As used in this disclosure, except where the context requires otherwise, the term “comprise” and variations of the term, such as “comprising”, “comprises” and “comprised” are not intended to exclude other additives, components, integers or steps.

In the following description, certain terminology is used to describe certain features of one or more embodiments of the invention. The term “towing hitch” refers to any device attached to the chassis of a vehicle for towing including a towbar. For example, a towing hitch can be one of the four classes of trailer hitches, based on the weight of the trailer and its cargo as defined by The Society of Automotive Engineers including ring and pintle as well as ball and socket.

In the following description, specific details are given to provide a thorough understanding of the embodiments. However, it will be understood by one of ordinary skill in the art that the embodiments may be practiced without these specific detail.

Various embodiments provide devices for a decorative towing hitch cover with a detachable decorative portion that provides security, protection and lubrication. One embodiment of the present invention provides a clean and secure device that does not require a user to handle the lubrication on the trailer hitch thereby alleviating the deficiencies of the prior art. There are, however, alternative embodiments that can provide different sizes and shapes of covers, with detachable decorations, including no decorations, to customize the user's vehicle in many different ways without the need to purchase another complete cover, thereby saving the user money and providing the most flexible and secure cover available. The device will now be disclosed in detail.

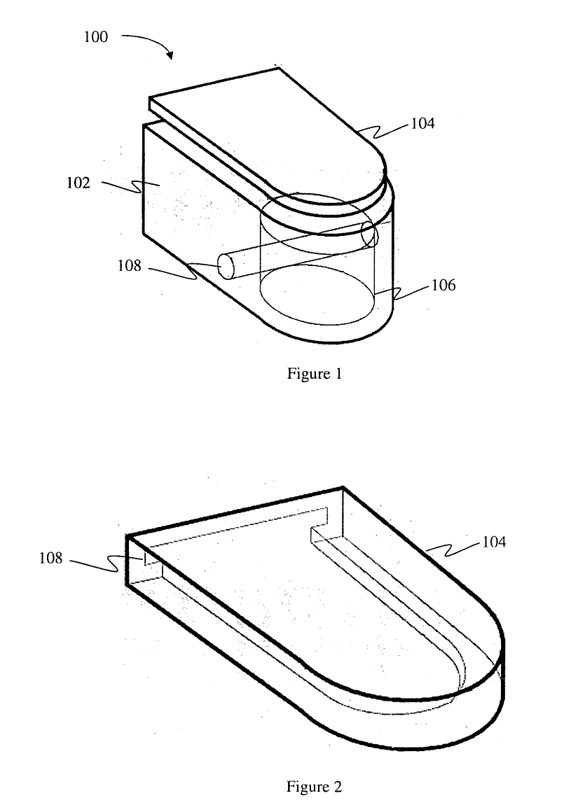

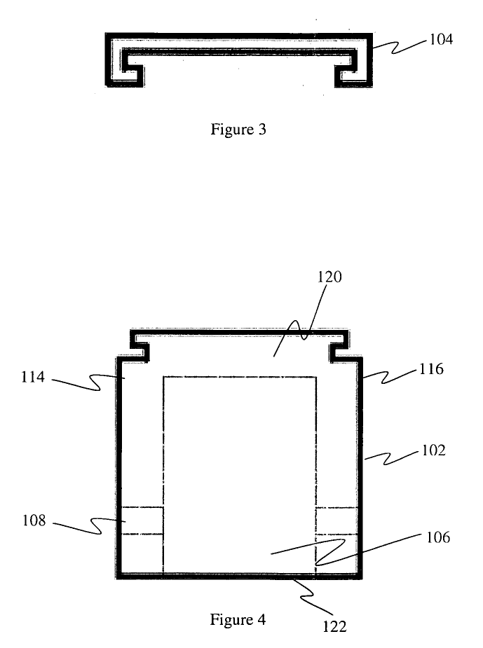

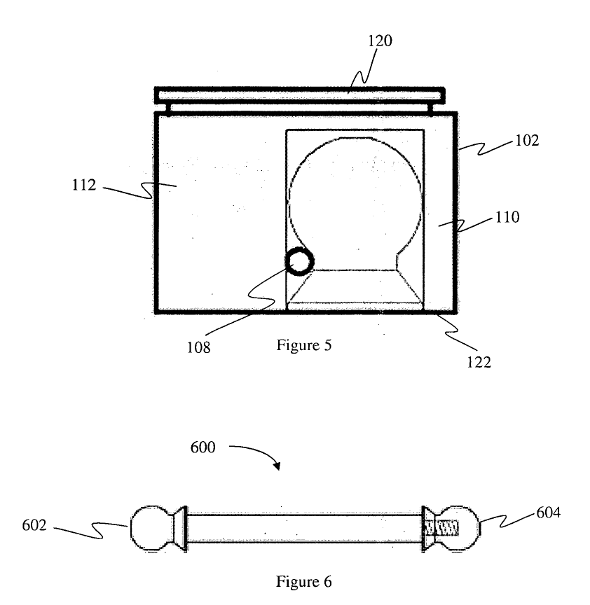

Referring now to FIGS. 1 through 6, there is shown a diagram of a perspective view of a decorative towing hitch cover 100 with a detachable decorative portion 104 according to one embodiment of the invention. The device towing hitch cover 100 device comprises a housing 102 operably connectable to a hitch assembly (not shown) and a detachable decorative portion 104 that is connected to the housing 102. The housing 102 further comprises a proximal end portion 110 and a distal end portion 112 that are connected to a mid-portion. An upper portion 120, a first side portion 114 and a second side portion 116 and a lower portion 122 are connected to each other to form the shape of the device. In one embodiment, the lower portion 122 has an aperture 106 positioned near the proximal end portion 110 of the housing 102. The aperture 106 is adapted to fit over a towing hitch such as, for example, a standard ball hitch or a ring and pintle hitch. An aperture 108 extends through the housing 102 and is adapted to allow passage of a lock mechanism. In a preferred embodiment, the aperture 108 is sized and placed to the design of the lock mechanism. In a particularly preferred embodiment, the lock mechanism is a span coupler lock 600 with a shaft 602 and a locking end cap 604. In another embodiment (not shown), the lock mechanism can be contained within the housing 102 and activated by electronic means such as, for example, an RFID key, an RF transmitter, a key pad, a key lock or the like could be used to unlock the device.

The detachable decorative portion 104 can be attached to the housing 102 using a variety of methods such as, for example, screws, cap screws, set screws, clasps, clamps, spring locks among others. In a particularly preferred embodiment, the detachable decorative portion 104 is slidably connected to the upper portion 120 of the housing 102 using a tongue and grove configuration as shown in FIGS. 2 through 4. This configuration prominently displays the decoration. The detachable decorative portion 104 provides the ability to switch decorations on the device 100, without removing the device 100 or purchasing an entirely new cover. In a similar manner, the detachable decorative portion 104 can be configured for the first side portion 114, the second side portion 116, or both the first side portion 114 and the second side portion 116 to display decorations. In another embodiment, the top portion 120, the first side portion 114 and the second side portion all comprise tongue and grove joints to accommodate detachable decorative portions 104.

In a preferred embodiment, the detachable decorative portion 104 has an affixed decoration selected from the group consisting of a figure, a fantasy figure, a lighted decorative pattern, seasonal and holiday lighted decorations, human female figurine, human male figurine, an animal figurine, motorized vehicles, watercraft vehicles, occupational models, religious figurines, sport logos, sports figures, photographs and religious symbols. In one embodiment, the lighted decorative patterns comprise light emitting diodes embedded into the detachable decorative portion 104 forming a pattern, such as a name or a design. The housing 102 can comprise a battery compartment so that the lighted decorative pattern can be lit when the vehicle is not operational. Optionally, a solar panel can be placed on top of the housing 102, and lighted decorative patterns on a detachable decorative portion (not shown) affixed to the first side portion 114, the second side portion 116 or both the first 114 and second 116 side portions.

In another embodiment, the housing 102 has an electrical connection (not shown) to the vehicle. Typically, the electrical connection is located at the distal portion 112 of the housing 102 for ease of use and neatness. The electrical connection can conduct electricity to provide power to the detachable decorative portion 104. For example, a standard trailer 12 volt connector can be affixed to the housing 102. Electrical wires from the 12 volt connector can be run to electrically conductive strips in the groove where detachable decorative portion 104 mates with the housing 102. Similarly, electrically conductive strips can be place opposite the strips in the housing 102, with electrical wires connected to the decoration. When the housing 102 and the detachable decorative portion 104 are mated the two sets of electrical strips would contact each other thereby providing electricity to the decoration.

In another embodiment, the housing 102 comprises a zero fitting for lubricating the hitch assembly. In this embodiment, the user is provided the means to conduct maintenance on the hitch portion of the vehicle without the need to remove the housing 102 or the decoration.

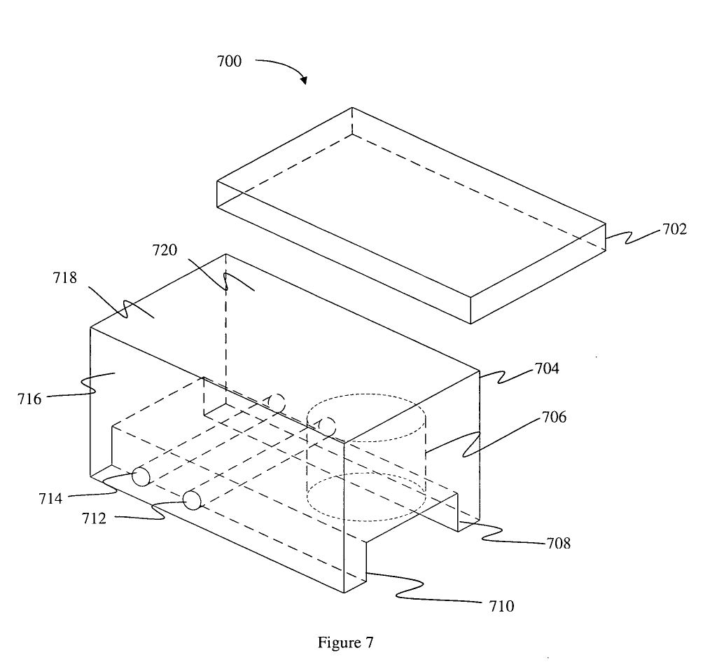

Referring now to FIG. 7, there is shown a perspective view of a diagram of a decorative towing hitch cover 700 with a detachable decorative portion 702 according to another embodiment of the invention. The towing hitch cover device 700 comprises a housing 704 operably connectable to a hitch assembly, wherein the housing 704 comprises a proximal end portion, a mid-portion connected to the proximal end portion, a distal end portion connected to the mid-portion, an upper portion 718 connected to the mid-portion, a first side portion 716 connected to the mid-portion, a second side portion 720 connected to the mid-portion and a lower portion connected to the mid-portion of the housing. In one embodiment, the device 700 comprises a channel having two sides 708 and 710 that is adapted to cover the hitch assembly. For example, on a tongue adapter with a ball hitch, the present invention would have a channel having two sides 708 and 710 of sufficient size and shape adapted to completely cover the exterior portion of the tongue as well as an aperture 706 to cover the ball hitch. The lower portion of the cover can be secured to the towing hitch assembly using one or more apertures 714 and 712 that extend through the housing with a lock mechanism. The lock mechanism can be a padlock, a cable lock, a coupler lock, a span lock, a key lock or others as will be understood by those with skill in the art with reference to this disclosure.

In a preferred embodiment, a decoration can be affixed to the detachable section of the cover and is selected from the group consisting of a figure, a fantasy figure, a lighted decorative pattern, seasonal and holiday lighted decorations, human female figurine, human male figurine, an animal figurine, motorized vehicles, watercraft vehicles, occupational models, religious figurines, sport logos, sports figures, photographs and religious symbols.

In another embodiment, the detachable decorative portion 702 of the towing hitch cover can be connect to the upper portion 718 of the housing, the first side portion 716 of the housing, the second side portion 720 of the housing, the upper portion 718 of the housing and the first side portion 716 of the housing, the upper portion 718 of the housing and the second side portion 720, or the first side portion 716 of the housing and the second side portion 720 of the housing. For example, the cover can have an embedded LED lighted design of a flag on the first side portion 716 and a name and/or date in the second side portion 720, and have a figure of a firefighter on the top portion 718.

What has been described is a new and improved device for covering towing hitches overcoming the limitations and disadvantages inherent in the related art. Although the present invention has been described with a degree of particularity, it is understood that the present disclosure has been made by way of example. As various changes could be made in the above description without departing from the scope of the invention, it is intended that all matter contained in the above description or shown in the accompanying drawings shall be illustrative and not used in a limiting sense.

What is claimed is:

1. A towing hitch covers device comprising:
a) a housing operably connectable to a hitch assembly; and
b) a detachable decorative portion connected to the housing.

2. The towing hitch cover device of claim 1, wherein the housing further comprises:
a) a proximal end portion;
b) a mid-portion connected to the proximal end portion;
c) a distal end portion connected to the mid-portion;
d) an upper portion connected to the mid-portion;
e) a first side portion connected to the mid-portion;
f) a second side portion connected to the mid-portion; and
g) a lower portion connected to the mid-portion, wherein the lower portion comprises an aperture, positioned at the proximal end portion, adapted to fit over the hitch assembly.

3. The towing hitch cover device of claim 2 wherein the lower portion further comprises a channel adapted to cover the hitch assembly.

4. The towing hitch cover device of claim 3 wherein the lower portion further comprises one or more apertures, extending through the housing and the channel, that are adapted to allow passage of a lock mechanism.

5. The towing hitch cover device of claim 2 wherein the housing further comprises one or more apertures extending through the mid-portion of the housing adapted to allow passage of a lock mechanism.

6. The towing hitch cover device of claim 2 wherein the detachable decorative portion further comprises a decoration selected from the group consisting of a figure, a fantasy figure, a lighted decorative pattern, seasonal and holiday lighted decorations, human female figurine, human male figurine, an animal figurine, motorized vehicles, watercraft vehicles, occupational models, religious figurines, sport logos, sports figures, photographs and religious symbols.

7. The towing hitch cover device of claim 6 wherein the detachable decorative portion is connectable to the upper portion of the housing, the first side portion of the housing, the second side portion of the housing, the upper portion of the housing and the first side portion of the housing, the upper portion of the housing and the second side portion, or the first side portion of the housing and the second side portion of the housing.

8. The towing hitch cover device of claim 6 wherein the detachable decorative portion comprises a means for attaching the detachable decorative portion to the housing.

9. The towing hitch cover device of claim 6 wherein the housing further comprises an electrical connection.

10. The towing hitch cover device of claim 9 wherein the electrical connection is located at the distal portion of the housing.

11. The towing hitch cover device of claim 9 wherein the detachable decorative portion comprises means for conducting electricity to provide power to the detachable decorative portion.

12. The towing hitch cover device of claim 1 wherein the housing further comprises a zero fitting for lubricating the hitch assembly.

13. The towing hitch cover device of claim 12 wherein the zero fitting is located on the upper portion at the proximal end portion of the housing.

14. A towing hitch cover device comprising:
a) a housing operably connectable to a hitch assembly, wherein the housing comprises a proximal end portion, a mid-portion connected to the proximal end portion, a distal end portion connected to the mid-portion, an upper portion connected to the mid-portion, a first side portion connected to the mid-portion, a second side portion connected to the mid-portion, and a lower portion connected to the mid-portion; and
b) a detachable decorative portion connected to the housing, wherein the detachable decorative portion comprises a decoration.

15. The towing hitch cover device of claim 14 wherein the lower portion comprises an aperture, positioned at the proximal end portion, adapted to fit over a towing hitch.

16. The towing hitch cover device of claim 14 wherein the lower portion further comprises a channel adapted to cover the hitch assembly.

17. The towing hitch cover device of claim 16 wherein the housing further comprises one or more apertures, extending through the housing and the channel, that are adapted to allow passage of a lock mechanism.

18. The towing hitch cover device of claim 14 wherein the housing further comprises one or more apertures extending through the mid-portion of the housing adapted to allow passage of a lock mechanism.

19. The towing hitch cover device of claim 14 wherein the decoration is selected from the group consisting of a figure, a fantasy figure, a lighted decorative pattern, seasonal and holiday lighted decorations, human female figurine, human male figurine, an animal figurine, motorized vehicles, watercraft vehicles, occupational models, religious figurines, sport logos, sports figures, photographs and religious symbols.

20. The towing hitch cover device of claim 14 wherein the detachable decorative portion is connectable to the upper portion of the housing, the first side portion of the housing, the second side portion of the housing, the upper portion of the housing and the first side portion of the housing, the upper portion of the housing and the second side portion, or the first side portion of the housing and the second side portion of the housing.
